(19) United States
(12) Patent Application Publication
(10) Pub. No.: US 2014/0301009 A1
(43) Pub. Date: Oct. 9, 2014

(54) ION DISCHARGE DEVICE

(71) Applicant: SHARP KABUSHIKI KAISHA, Osaka-shi, Osaka (JP)

(72) Inventor: Tsuyoshi Ogawa, Osaka-shi (JP)

(73) Assignee: SHARP KABUSHIKI KAISHA, Osaka-shi, Osaka (JP)

(21) Appl. No.: 14/354,323

(22) PCT Filed: Sep. 19, 2012
(86) PCT No.: PCT/JP2012/073903

§ 371 Date: Apr. 25, 2014

(30) Foreign Application Priority Data
Oct. 27, 2011 (JP) 2011-235750

(51) Int. Cl. H01T 23/00

(52) U.S. Cl. CPC H01T 23/00
USPC 361/231

(57) ABSTRACT

There is provided an ion discharge device including: a housing (2) to which a first outlet port (13) and a second outlet port (23) are open; a positive ion generation portion (31) which generates a positive ion; a negative ion generation portion (32) which generates a negative ion; a first blower duct (11) in which the positive ion generation portion (31) is arranged and which is formed with a dielectric; and a second blower duct (21) in which the negative ion generation portion (32) is arranged and which is formed with a dielectric, where the positive ion is discharged through the first outlet port (13), the negative ion is discharged through the second outlet port (23) and the first blower duct (11) and the second blower duct (21) are grounded.

### TECHNICAL FIELD

The present invention relates to an ion discharge device that discharges positive ions and negative ions.

### BACKGROUND ART

A conventional ion discharge device is disclosed in patent document 1. This ion discharge device forms an air cleaner, and within a housing, a first blower duct and a second blower duct formed with a resin molded item of a dielectric are provided. The first blower duct makes a first inlet port open to one side surface of the housing communicate with a first outlet port open to a top surface. The second blower duct makes a second inlet port open to a side surface of the housing opposite the first inlet port communicate with a second outlet port open to the top surface. At the first inlet port and the second inlet port, a dust collection filter that collects dust is arranged.

In the first blower duct and the second blower duct, a blower fan is arranged. The blower fan is formed with a Sirocco fan, and two impellers that are driven by a common fan motor are provided coaxially. The impellers are individually arranged within the first blower duct and the second blower duct, and the impellers are rotated by the fan motor to pass an air current to the first blower duct and the second blower duct.

In each of the first blower duct and the second blower duct, an ion generation device is arranged. The ion generation device includes a first discharge electrode to which a positive high voltage is applied and a second discharge electrode to which a negative high voltage is applied. Positive ions of air ions are generated by the discharge of the first discharge electrode, and negative ions of air ions are generated by the discharge of the second discharge electrode.

In the ion discharge device configured as described above, air within a room is taken in the first and second blower ducts, by the drive of the blower fan, through the first and second inlet ports. Dust contained in the air is collected by the dust collection filter. The air from which the dust is removed contains the positive ions and the negative ions generated by the ion generation device, and they are discharged through the first and second outlet ports. By the positive ions and the negative ions discharged through the first and second outlet ports, floating bacteria and odorous components in the air are destroyed, and thus it is possible to sterilize and deodorize the interior of the room.

### RELATED ART DOCUMENT

### Patent Document

Patent document 1: JP-A-2010-80425 (pages 6 to 14 and FIG. 1)

### DISCLOSURE OF THE INVENTION

### Problems to be Solved by the Invention

However, in the conventional ion discharge device described above, the positive ions and the negative ions generated by the ion generation device collide with each other while they are passed through the first and second blower ducts. Hence, neutralizing deactivation occurs in which ions disappear by colliding with each other, and thus the number of ions discharged is reduced, with the result that it is disadvantageously impossible to sufficiently obtain the effect of sterilizing the interior of the room.

An object of the present invention is to provide an ion discharge device that can increase the number of ions discharged.

### Means for Solving the Problem

To achieve the above object, according to the present invention, there is provided an ion discharge device including: a housing to which a first outlet port and a second outlet port are open; a positive ion generation portion which generates a positive ion by discharge of a first discharge electrode to which a positive voltage is applied; a negative ion generation portion which generates a negative ion by discharge of a second discharge electrode to which a negative voltage is applied; a first blower duct which includes the first outlet port at an open end, in which the positive ion generation portion is arranged and which is formed with a dielectric; a second blower duct which includes the second outlet port at an open end, in which the negative ion generation portion is arranged and which is formed with a dielectric; and a blower fan which passes an air current to the first blower duct and the second blower duct, where the positive ion is discharged through the first outlet port, the negative ion is discharged through the second outlet port and the first blower duct and the second blower duct are grounded.

In this configuration, the air current is passed to the first blower duct and the second blower duct formed with the dielectric by the drive of the blower fan. The positive ions generated in the positive ion generation portion by the discharge of the first discharge electrode are contained in the air current passed to the first blower duct where electricity is eliminated by the grounding, and are discharged through the first outlet port. The negative ions generated in the negative ion generation portion by the discharge of the second discharge electrode are contained in the air current passed to the second blower duct where electricity is eliminated by the grounding, and are discharged through the second outlet port. By the positive ions and the negative ions discharged through the first and second outlet ports, floating bacteria and odorous components within the room are destroyed, and thus it is possible to sterilize and deodorize the interior of the room.

Moreover, according to the present invention, in the ion discharge device configured as described above, the first blower duct grounds an upstream side of the positive ion generation portion, and the second blower duct grounds an upstream side of the negative ion generation portion. In this configuration, the first and second blower ducts maintain the potential of the upstream side of the positive ion generation portion and the negative ion generation portion at the ground potential. The ions generated in the positive ion generation portion and the negative ion generation portion are guided to the first and second outlet ports on the downstream side.

Moreover, according to the present invention, in the ion discharge device configured as described above, the positive ion generation portion includes a first induction electrode opposite the first discharge electrode, a voltage is applied between the first discharge electrode and the first induction electrode and the first discharge electrode discharges, the negative ion generation portion includes a second induction electrode opposite the second discharge electrode, a voltage is applied between the second discharge electrode and the second induction electrode and the second discharge electrode discharges and the first blower duct and the second blower duct are electrically connected to the first induction electrode and the second induction electrode that are electrically continuous to each other.

In this configuration, a positive voltage is applied between the first induction electrode and the first discharge electrode, and thus the first discharge electrode discharges. Moreover, a negative voltage is applied between the second induction electrode and the second discharge electrode electrically continuous to the first induction electrode, and thus the second discharge electrode discharges. The first blower duct and the second blower duct are electrically connected to the first induction electrode and the second induction electrode, and thus they are grounded.

Moreover, according to the present invention, in the ion discharge device configured as described above, the first induction electrode and the second induction electrode are electrically continuous to a metal portion provided in the housing so as to be subjected to frame ground. In this configuration, the first blower duct and the second blower duct are subjected to frame ground through the first and second induction electrodes.

Moreover, according to the present invention, in the ion discharge device configured as described above, the first blower duct and the second blower duct are grounded through a resistor.

Moreover, according to the preset invention, in the ion discharge device configured as described above, the resistor has a resistance of 2 MΩ or more.

Moreover, according to the present invention, in the ion discharge device configured as described above, the positive ion and the negative ion are an air ion or charged particle water.

### Advantages of the Invention

In the present invention, since the positive ion generation portion is arranged in the grounded first blower duct, and the negative ion generation portion is arranged in the grounded second blower duct, it is possible to reduce neutralizing deactivation caused by the collision of the positive ions and the negative ions. Since the first and second blower ducts are grounded, and thus electricity is eliminated, the potential gradient in the first and second blower ducts is reduced. In this way, since the adverse effect of the potential gradient on the electric field that generates the ions is decreased, it is possible to increase the number of ions generated. Hence, it is possible to increase the number of ions discharged to enhance the sterilizing effect and the deodorizing effect.

### BRIEF DESCRIPTION OF DRAWINGS

FIG. 1 A front cross-sectional view showing an ion discharge device according to a first embodiment of the present invention;

FIG. 2 A side cross-sectional view showing the ion discharge device according to the first embodiment of the present invention;

FIG. 3 A perspective view showing an ion generation device of the ion discharge device according to the first embodiment of the present invention;

FIG. 4 A circuit diagram of the ion generation device of the ion discharge device according to the first embodiment of the present invention;

FIG. 5 A perspective view showing measurement points at which ion concentrations within a room are measured by the ion discharge device according to the first embodiment of the present invention; and

FIG. 6 A circuit diagram of an ion generation device of an ion discharge device according to a second embodiment of the present invention.

### DESCRIPTION OF EMBODIMENTS

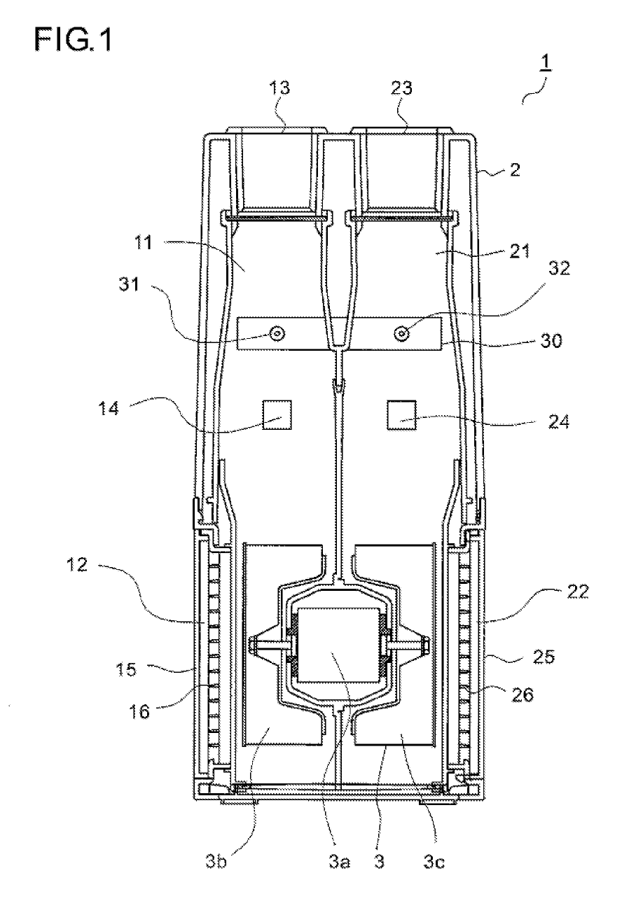

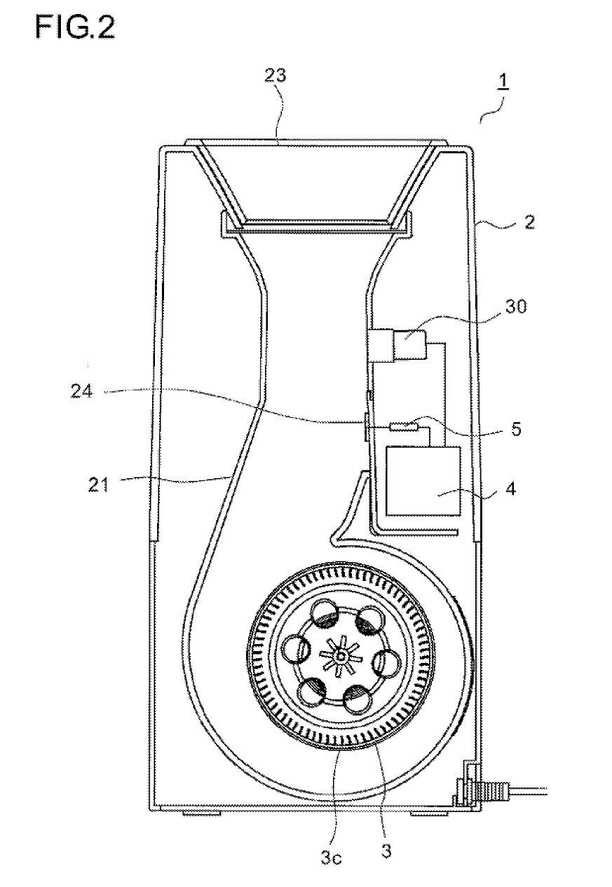

Embodiment of the present invention will be described below with reference to accompanying drawings. FIGS. 1 and 2 show a front cross-sectional view and a side cross-sectional view of an ion discharge device according to a first embodiment. The ion discharge device 1 forms an air cleaner, and within a housing 2, a first blower duct 11 and a second blower duct 21 formed with a resin molded item of a dielectric are provided side by side in a left/right direction.

The first blower duct 11 makes a first inlet port 12 open to one side surface of the housing 2 communicate with a first outlet port 13 open to a top surface. At the first inlet port 12, a dust collection filter 15 that collects dust and a ventilation plate 16 where a plurality of ventilation holes are open are arranged. The second blower duct 21 makes a second inlet port 22 open to a side surface opposite the first inlet port 12 of the housing 2 communicate with a second outlet port 23 open to the top surface. In the second inlet port 22, a dust collection filter 25 that collects dust and a ventilation plate 26 where a plurality of ventilation holes are open are arranged.

In the first blower duct 11 and the second blower duct 21, a blower fan 3 is arranged. The blower fan 3 is formed with a Sirocco fan, and two impellers 3b and 3c that are driven by a common fan motor 3a are provided coaxially. The impeller 3b is arranged within the first blower duct 11 so as to face the first inlet port 12, and the impeller 3c is arranged within the second blower duct 21 so as to face the second inlet port 22. The impellers 3b and 3c are rotated by the fan motor 3a to pass an air current to the first blower duct 11 and the second blower duct 21.

Within the housing 2, an ion generation device 30 that includes a positive ion generation portion 31 and a negative ion generation portion 32, which will be described later, are arranged. The positive ion generation portion 31 is arranged to face the first blower duct 11, and the negative ion generation portion 32 is arranged to face the second blower duct 21.

In the first blower duct 11 and the second blower duct 21, between the blower fan 3 and the ion generation device 30, ground electrodes 14 and 24 are provided.

In the back portion of the housing 2, a control portion 4 that drives and controls the blower fan 3 and the ion generation device 30 is arranged. The control portion 4 includes a ground terminal (not shown) that is electrically continuous to a metal plate (a metal portion, not shown) provided in the housing 2 and that is subjected to frame ground. The ground electrodes 14 and 24 are connected to the ground terminal with a conductor through a resistor 5, and are maintained at a ground potential.

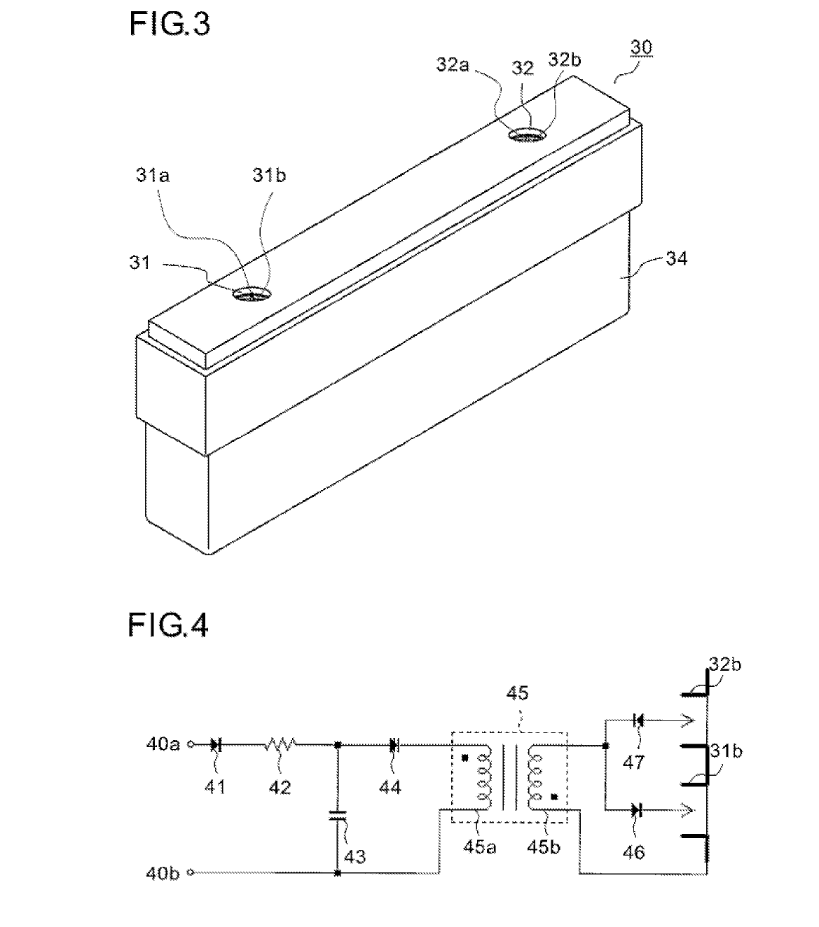

FIG. 3 shows a perspective view of the ion generation device 30. The ion generation device 30 is covered with a cover 34 of a dielectric such as ceramic. Within the cover 34, a circuit substrate (not shown) is provided on which a first discharge electrode 31a, a first induction electrode 31b, a second discharge electrode 32a, a second induction electrode 32b and a drive circuit are mounted. The first discharge electrode 31a and the first induction electrode 31b form the positive ion generation portion 31, and the second discharge electrode 32a and the second induction electrode 32b form the negative ion generation portion 32.

The first discharge electrode 31a and the second discharge electrode 32a are formed in the shape of a needle, and are provided parallel to each other a predetermined distance apart. The first induction electrode 31b is formed annularly with the first discharge electrode 31a in the center, and is opposite the first discharge electrode 31a. The second induction electrode 32b is formed annularly with the second discharge electrode 32a in the center, and is opposite the second discharge electrode 32a.

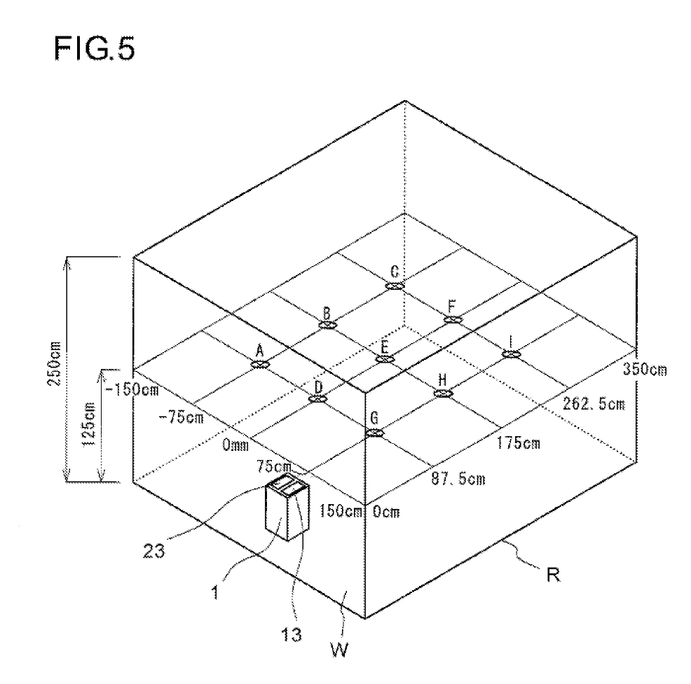

FIG. 4 is a circuit diagram showing the drive circuit of the ion generation device 30. Terminals 40a and 40b at the one ends of the drive circuit are connected to a power supply circuit (not shown). A current in a predetermined direction is passed from the power supply circuit between the terminals 40a and 40b to apply a voltage therebetween, and thus a capacitor 43 is charged through a diode 41 and a resistor 42.

When the voltage across the terminals of the capacitor 43 is increased to reach the break-over voltage of a two-terminal thyristor 44, the two-terminal thyristor 44 operates as a Zener diode to further pass current. When the current flowing through the two-terminal thyristor 44 reaches a break-over current, the two-terminal thyristor 44 is brought into a substantially short-circuit state. Thus, the charge stored in the capacitor 43 is discharged through the two-terminal thyristor 44 and the primary wining 45a of a pulse transformer 45, and an impulse voltage is produced in the primary wining 45a.

When the impulse voltage is produced in the primary wining 45a, in the secondary winding 45b of the pulse transformer 45, positive and negative high-voltage pulses are produced while being attenuated in an alternate manner. The first induction electrode 31b and the second induction electrode 32b become electrically continuous, and are connected to one end of the secondary winding 45b. The other ends of the secondary winding 45b are connected through diodes 46 and 47 to the first discharge electrode 31a and the second discharge electrode 32a, respectively.

Hence, the positive high-voltage pulse produced in the secondary winding 45b, is applied through the diode 46 to the first discharge electrode 31a. Thus, corona discharge is produced at the top end of the first discharge electrode 31a. The negative high-voltage pulse generated in the secondary winding 45b is applied through the diode 47 to the second discharge electrode 32a. Thus, corona discharge is produced at the top end of the second discharge electrode 32a. Although a high voltage is alternately applied to the first and second discharge electrodes 31a and 32a at predetermined intervals, two independent drive circuits may be provided to apply a high voltage at the same time.

Water molecules in the air are ionized by the corona discharge of the first discharge electrode 31a to produce hydrogen ions. The hydrogen ions and the water molecules in the air are clustered by solvation energy. In this way, the positive ions of air ions formed with H⁺(H₂O)ₘ (m is either zero or an arbitrary natural number) are discharged from the positive ion generation portion 31.

Moreover, oxygen molecules or water molecules in the air are ionized by the corona discharge of the second discharge electrode 32a to produce oxygen ions. The oxygen ions and the water molecules in the air are clustered by solvation energy. In this way, the negative ions of air ions formed with O₂⁻(H₂O)ₙ (n is an arbitrary natural number) are discharged from the negative ion generation portion 32.

H⁺(H₂O)ₘ and O₂⁻(H₂O)ₙ are aggregated on the surfaces of airborne bacteria and odor components in the air to surround them. As shown in formulas (1) to (3), [. OH] (hydroxyl radical) and H₂O₂ (hydrogen peroxide) that are active species are aggregated and generated on the surface of microorganisms and the like to break down airborne bacteria and odor components. Here, m′ and n′ are arbitrary natural numbers. Hence, by discharging the positive ions and the negative ions into the room, it is possible to sterilize and deodorize the interior of the room.

H⁺(H₂O)ₘ+O₂⁻(H₂O)ₙ→.OH+½O₂+(m+n)H₂O (1)

H⁺(H₂O)ₘ+H⁺(H₂O)ₘ′+O₂⁻(H₂O)ₙ+O₂⁻(H₂O)ₙ′→2.OH+O₂+(m+m′+n+n′)H₂O (2)

H⁺(H₂O)ₘ+H⁺(H₂O)ₘ′+O₂⁻(H₂O)ₙ+O₂⁻(H₂O)ₙ′→H₂O₂+O₂+(m+m′+n+n′)H₂O (3)

In the ion discharge device 1 configured as described above, the air within the room is taken in the first and second blower ducts 11 and 21 by the drive of the blower fan 3 through the first and second inlet ports 12 and 22, respectively. Dust contained in the air is collected by the dust collection filters 15 and 25.

The air from which the dust is removed and which is passed through the first blower duct 11 contains the positive ions generated by the positive ion generation portion 31, and is discharged through the first outlet port 13. The air from which the dust is removed and which is passed through the second blower duct 21 contains the negative ions generated by the negative ion generation portion 32, and is discharged through the second outlet port 23. Here, since the positive ions and the negative ions are separated and passed through the first blower duct 11 and the second blower duct 21, and thus it is possible to reduce the neutralizing deactivation of the ions and increase the number of ions discharged.

By the positive ions and the negative ions discharged through the first and second outlet ports 13 and 23, floating bacteria and odorous components in the air are destroyed, and thus it is possible to sterilize and deodorize the interior of the room.

Since the first and second blower ducts 11 and 21 are formed with a dielectric, when either the positive ions or the negative ions are passed, they are charged by the ions to produce a potential gradient in the inner wall. When a potential in the vicinity of the ion generation device 30 is increased by the potential gradient this adversely affects an electric field that generates the ions in the ion generation device 30, and thus the number of ions generated is reduced.

Hence, the first blower duct 11 is grounded with the ground electrode 14, and thus electricity is eliminated, with the result that the charge by the positive ions is reduced. Likewise, the second blower duct 21 is grounded with the ground electrode 24, and thus electricity is eliminated, with the result that the charge by the negative ions is reduced. Thus, it is possible to increase the number of ions generated to more increase the number of ions discharged.

Here, when the first and second blower ducts 11 and 21 are charged to a high potential through the application of a high voltage by the ion generation device 30, the current flowing through the ground electrodes 14 and 24 is increased. Hence, it is possible to decrease, with the resistor 5, the current flowing through the ground electrodes 14 and 24. The resistance of the resistor 5 is set equal to or more than 2 MΩ, and thus it is possible to reliably decrease the current flowing through the ground electrodes 14 and 24.

In the first and second blower ducts 11 and 21, a slight potential gradient is produced in a position away from the ground electrodes 14 and 24 where the potential is maintained at the ground potential. Hence, the positive ions repel the first blower duct 11 charged to a positive potential, and thus they easily flow out through the first outlet port 13. Likewise, the negative ions repel the second blower duct 21 charged to a negative potential, and thus they easily flow out through the second outlet port 23.

Here, since when the ground electrodes 14 and 24 are arranged on a downstream side of the positive ion generation portion 31 and the negative ion generation portion 32, respectively, the positive ions and the negative ions do not repel the ground electrodes 14 and 24 whose potential is the ground potential, they may be adsorbed. Hence, the ground electrodes 14 and 24 are arranged on an upstream side of the positive ion generation portion 31 and the negative ion generation portion 32, respectively, and thus it is possible to reduce the adsorption of the ions to more increase the number of ions discharged.

FIG. 5 is a perspective view showing measurement points (9 points) at which the ion discharge device 1 was placed within a test room and the ion concentration was measured. The test room R is formed such that the width is 300 cm, the depth is 350 cm and the height is 250 cm. The ion discharge device 1 is arranged 30 cm away from the center of one side wall W forming the direction of the width of the test room R. The height of the ion discharge device 1 (the height of the surface where the first and second outlet ports 13 and 23 are formed) is 90 cm. The volume of air by the ion discharge device 1 is 1.2 m³/min.

The height of the measurement points A to I is 125 cm. The measurement points A, B and C are 75 cm away in the rightward direction (the side where the second outlet port 23 is arranged) opposite the center of the side wall W. The measurement points D, E and F are arranged on a vertical plane (the front surface of the ion discharge device 1) passing through the center of the side wall W. The measurement points G, H and I are 75 cm away in the leftward direction (the side where the first outlet port 13 is arranged) opposite the center of the side wall W.

The measurement points A, D and G are 87.5 cm away in the direction of the depth with respect to the side wall W. The measurement points B, E and H are 175 cm away in the direction of the depth with respect to the side wall W. The measurement points C, F and I are 262.5 cm away in the direction of the depth with respect to the side wall W.

Table 1 shows the results of the measurements of ion concentrations (unit: pieces/cm³) of the positive ions and the negative ions at the measurement points A to I. For comparison, table 2 shows results obtained by likewise measuring ion concentrations with the conductor for grounding the ground electrodes 14 and 24 removed.

TABLE 1

| | Right 75 cm | | | | | | Left 75 cm | | |
|---|---|---|---|---|---|---|---|---|---|
| | (negative side) | | | 0 cm (front surface) | | | (positive side) | | |
| | Position | +ion | −ion | Position | +ion | −ion | Position | +ion | −ion |
| 87.5 cm | A | 18,600 | 20,300 | D | 13,200 | 12,800 | G | 28,000 | 12,800 |
| 175.0 cm | B | 24,600 | 25,000 | E | 75,600 | 60,400 | H | 24,600 | 18,800 |
| 262.5 cm | C | 24,400 | 30,400 | F | 83,000 | 78,800 | I | 25,400 | 19,600 |

TABLE 2

| | Right 75 cm | | | | | | Left 75 cm | | |
|---|---|---|---|---|---|---|---|---|---|
| | (negative side) | | | 0 cm (front surface) | | | (positive side) | | |
| | Position | +ion | −ion | Position | +ion | −ion | Position | +ion | −ion |
| 87.5 cm | A | 29,900 | 15,600 | D | 21,900 | 5,400 | G | 28,700 | 4,600 |
| 175.0 cm | B | 37,100 | 4,600 | E | 73,900 | 17,300 | H | 35,300 | 700 |
| 262.5 cm | C | 45,900 | 13,800 | F | 120,700 | 15,400 | I | 32,900 | 3,900 |

According to tables 1 and 2, when the first and second blower ducts 11 and 21 are not grounded, the concentration of the negative ions is low, and the balance of the concentrations of the positive and negative ions is poor. On the other hand, when the first and second blower ducts 11 and 21 are grounded, the concentrations of the positive and negative ions are high, and the balance of the concentrations of the positive and negative ions is improved.

In the present embodiment, since the positive ion generation portion 31 is arranged in the grounded first blower duct 11, and the negative ion generation portion 32 is arranged in the grounded second blower duct 21, it is possible to reduce neutralizing deactivation caused by the collision of the positive ions and the negative ions. Since the first and second blower ducts 11 and 21 are grounded to eliminate electricity, the potential gradient in the first and second blower ducts 11 and 21 is reduced. In this way, since the adverse effect of the potential gradient on the electric field that generates the ions is decreased, it is possible to increase the number of ions generated. Hence, it is possible to increase the number of ions discharged to enhance the sterilizing effect and the deodorizing effect.

The first blower duct 11 is grounded with the ground electrode 24 on the upstream side of the positive ion generation portion 31, and the second blower duct 21 is grounded with the ground electrode 24 on the upstream side of the negative ion generation portion 32. Thus, it is possible to reduce the adsorption of the ions by a ground potential part to more increase the number of ions discharged.

Since the first blower duct 11 and the second blower duct 21 are grounded through the resistor 5, it is possible to decrease the current flowing through the ground electrodes 14 and 24. The resistor 5 is set equal to or more than 2 MΩ, and thus it is possible to reliably decrease the current flowing through the ground electrodes 14 and 24.

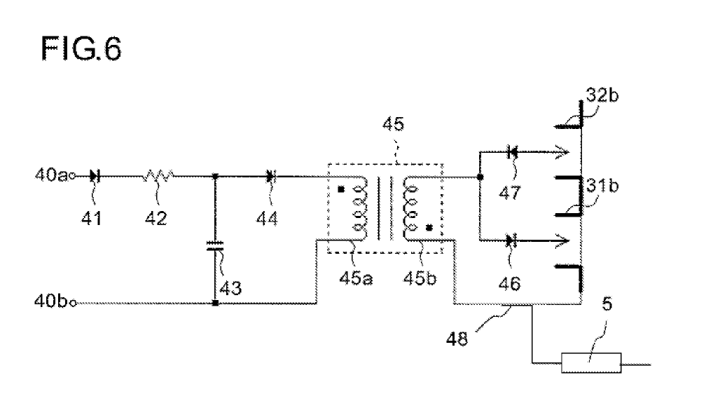

FIG. 6 shows the drive circuit of the ion generation device 30 of the ion discharge device 1 according to a second embodiment. For case of description, the same parts as shown in FIGS. 1 to 5 described above and in the first embodiment are identified with the same symbols. In the present embodiment, the ground electrodes 14 and 24 are connected to a secondary common terminal 48 of the drive circuit. The other parts are the same as in the first embodiment.

The secondary common terminal 48 is connected to one end of the secondary winding 45b of the pulse transformer 45, and is electrically continuous to the first induction electrode 31b and the second induction electrode 32b. The secondary common terminal 48 is also connected to the metal plate (the metal portion, not shown) of the housing 2, and is subjected to frame ground. The secondary common terminal 48 may be connected to the ground terminal of the control portion 4 so as to be subjected to frame ground. The ground electrodes 14 and 24 are connected through the resistor 5 to the secondary common terminal 48. Thus, the ground electrodes 14 and 24 are electrically connected to the first induction electrode 31b and the second induction electrode 32b, which are electrically continuous to each other, so as to be grounded.

Hence, it is possible to obtain the same effects as in the first embodiment. It is also possible to electrically connect the ground electrodes 14 and 24 to the first induction electrode 31b and the second induction electrode 32b, which are electrically continuous to each other and thereby easily ground the first and second blower ducts 11 and 21.

Although in the first and second embodiments, the positive ion generation portion 31 and the negative ion generation portion 32 generate the positive ions and the negative ions of the air ions, the present invention is not limited to this configuration. For example, the positive ion generation portion 31 and the negative ion generation portion 32 may be formed with an electrostatic atomizer.

Specifically, a discharge electrode provided in the electrostatic atomizer is cooled by a Peltier element, and thus dew condensation water is produced on the surface of the discharge electrode. Then, a negative high voltage is applied to the discharge electrode, and thus charged particle water containing negative ions is generated from the dew condensation water. A positive high voltage is applied to the discharge electrode, and thus charged particle water containing positive ions is generated from the dew condensation water. In this way, a positive ion generation portion and a negative ion generation portion are formed, and thus it is possible to discharge the positive ions and the negative ions and thereby sterilize the interior of the room.

### INDUSTRIAL APPLICABILITY

The present invention can be utilized for an ion discharge device that discharges positive ions and negative ions.

### LIST OF REFERENCE SYMBOLS

1 ion discharge device
2 housing
3 blower fan
4 control portion
5 resistor
11 first blower duct
12 first inlet port
13 first outlet port
14, 24 ground electrode
15, 25 dust collection filter
21 second blower duct
22 second inlet port
23 second outlet port
30 ion generation device
31 positive ion generation portion
31a first discharge electrode
31b first induction electrode
32 negative ion generation portion
32a second discharge electrode
32b second induction electrode
48 secondary common terminal

1. An ion discharge device comprising:
a housing to which a first outlet port and a second outlet port are open;
a positive ion generation portion which generates a positive ion by discharge of a first discharge electrode to which a positive voltage is applied;
a negative ion generation portion which generates a negative ion by discharge of a second discharge electrode to which a negative voltage is applied;
a first blower duct which includes the first outlet port at an open end, in which the positive ion generation portion is arranged and which is formed with a dielectric;
a second blower duct which includes the second outlet port at an open end, in which the negative ion generation portion is arranged and which is formed with a dielectric; and
a blower fan which passes an air current to the first blower duct and the second blower duct,
wherein the positive ion is discharged through the first outlet port, the negative ion is discharged through the second outlet port and the first blower duct and the second blower duct are grounded.

2. The ion discharge device of claim 1,
wherein the first blower duct grounds an upstream side of the positive ion generation portion, and the second blower duct grounds an upstream side of the negative ion generation portion.

3. The ion discharge device of claim 1,
wherein the positive ion generation portion includes a first induction electrode opposite the first discharge electrode, a voltage is applied between the first discharge electrode and the first induction electrode and the first discharge electrode discharges,
the negative ion generation portion includes a second induction electrode opposite the second discharge electrode, a voltage is applied between the second discharge electrode and the second induction electrode and the second discharge electrode discharges and
the first blower duct and the second blower duct are electrically connected to the first induction electrode and the second induction electrode that are electrically continuous to each other.

4. The ion discharge device of claim 3,
wherein the first induction electrode and the second induction electrode are electrically continuous to a metal portion provided in the housing so as to be subjected to frame ground.

5. The ion discharge device of claim 1,
wherein the first blower duct and the second blower duct are grounded through a resistor.

6. The ion discharge device of claim 5,
wherein the resistor has a resistance of 2 MΩ or more.

7. The ion discharge device of claim 1,
wherein the positive ion and the negative ion are an air ion or charged particle water.
